(19) United States
(12) Patent Application Publication
(10) Pub. No.: US 2025/0338151 A1
(43) Pub. Date: Oct. 30, 2025

(54) SIGNAL MEASUREMENT IN NON-TERRESTRIAL NETWORKS WITH QUASI-EARTH-FIXED CELLS

(71) Applicant: Lenovo (Singapore) Pte. Limited, Singapore (SG)

(72) Inventors: Majid Ghanbarinejad, Lake Forest, CA (US); Vijay Nangia, Woodridge, IL (US); Sher Ali Cheema, Ilmenau (DE); Hyejung Jung, Northbrook, IL (US)

(73) Assignee: Lenovo (Singapore) Pte. Limited, Singapore (SG)

(21) Appl. No.: 18/866,212

(22) PCT Filed: May 12, 2023
(86) PCT No.: PCT/IB2023/054905

§ 371 Date: Nov. 15, 2024

Related U.S. Application Data
(60) Provisional application No. 63/343,448, filed on May 18, 2022.

(51) Int. Cl. H04W 24/08; H04B 7/185; H04W 72/044

(52) U.S. Cl. CPC H04W 24/08; H04B 7/18541; H04W 72/044

(57) ABSTRACT

Various aspects of the present disclosure relate to quasi-Earth-fixed cells, where a non-geostationary orbit (NGSO) satellite fixes a cell with respect to the ground using beamforming, switching from one beam to the next beam frequently to simulate Earth-fixed beams or cells. Information regarding quasi-Earth-fixed beam switching is indicated to a user equipment (UE), such as at least one of beam fixing time durations, start of beam dwelling periods, or an estimate of the sudden decrease of increase in the signal strength due to quasi-Earth-fixed beam switching. Once the UE is informed of this information, the UE may use the information in different ways to compensate or adjust its measurements and the resulting actions (if any) accordingly.

### RELATED APPLICATION

This application claims priority to U.S. patent application Ser. No. 63/343,448 filed May 18, 2022 entitled “Signal Measurement in Non-Terrestrial Networks with Quasi-Earth-Fixed Cells,” the disclosure of which is incorporated by reference herein in its entirety.

### TECHNICAL FIELD

The present disclosure relates to wireless communications, and more specifically to signal measurement in non-terrestrial networks with quasi-Earth-fixed cells.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system, such as time resources (e.g., symbols, slots, subslots, mini-slots, aggregated slots, subframes, frames, or the like) or frequency resources (e.g., subcarriers, carriers). Additionally, the wireless communications system may support wireless communications across various radio access technologies (RATs) including third generation (3G) RAT, fourth generation (4G) RAT, fifth generation (5G) RAT, and other suitable RATs beyond 5G. In some cases, a wireless communications system may be a non-terrestrial network (NTN), which may support various communication devices for wireless communications in the NTN. For example, an NTN may include network entities onboard non-terrestrial vehicles such as satellites, unmanned aerial vehicles (UAV), and high-altitude platforms systems (HAPS), as well as network entities on the ground, such as gateway entities capable of transmitting and receiving over long distances.

Various types of cells may be supported in an NTN that includes low-earth orbit (LEO) satellites, medium-earth orbit (MEO) satellites, highly-elliptical orbit (HEO) satellites, or the like, collectively referred to as non-geostationary orbit (NGSO) satellites. One type of cell is an Earth-moving cell, which refers to the scenario where the cell moves as the NGSO satellite travels in the orbit. Another type of cell is an Earth-fixed cell, which refers to the scenario where the NGSO satellite fixes the cell with respect to the ground.

### SUMMARY

The present disclosure relates to methods, apparatuses, and systems that support signal measurement in non-terrestrial networks with quasi-Earth-fixed cells. Quasi-Earth-fixed cells refers to the scenario where an NGSO satellite fixes a cell with respect to the ground using beamforming, switching from one beam to the next beam frequently to simulate Earth-fixed beams/cells. The techniques discussed herein indicate information regarding quasi-Earth-fixed beam switching to the UE, such as at least one of beam fixing time durations, start of beam dwelling periods, or an estimate of the sudden decrease of increase in the signal strength due to quasi-Earth-fixed beam switching. Once the UE is informed of this information, the UE may use the information in different ways to compensate or adjust its measurements and the resulting actions (if any) accordingly. By utilizing the described techniques, a UE is able to account for changes in signal quality measurements when an NGSO satellite is switching from one beam to another.

Some implementations of the method and apparatuses described herein may include wireless communication at a device (e.g., a UE), and the device receives a first signaling indicating a cell movement type associated with a wireless cell; and takes, based at least in part on the cell movement type being quasi-Earth-fixed, one or more actions to account for the cell movement type being quasi-Earth-fixed.

In some implementations of the method and apparatuses described herein, to take the one or more actions is to neglect an increase or a decrease of a quality of a signal of the wireless cell within a threshold quality value. Additionally or alternatively, the device is further configured to: receive a second signaling indicating a value of beam fixing duration for the wireless cell; and wherein to take the one or more actions is to discard, if a signal measurement is older than the beam fixing duration, the signal measurement as obsolete. Additionally or alternatively, the device is further configured to: receive a second signaling indicating a time instant at which a beam switching occurs; and wherein to take the one or more actions is to neglect an increase or a decrease of a signal quality for a threshold amount of time after the time instant. Additionally or alternatively, the first signaling indicates a quasi-collocation relationship of a type “quasi-fixed” or “quasi-Earth-fixed”. Additionally or alternatively, to take the one or more actions is to: learn a signal quality pattern of the signal; and adjust a signal quality measurement based at least in part on the signal quality pattern. Additionally or alternatively, to take the one or more actions is to: use signal quality measurements without averaging consecutive signal quality measurements. Additionally or alternatively, the device is further to: receive a second signaling indicating a beam fixing duration for the wireless cell; and wherein to take the one or more actions is to use signal quality measurements without averaging the signal quality measurements over a window longer than the beam fixing duration. Additionally or alternatively, the device comprises a user equipment.

Some implementations of the method and apparatuses described herein may include wireless communication at a device (e.g., a base station), and the device transmit, to a UE, a first signaling indicating a cell movement type associated with a wireless cell is quasi-Earth-fixed; and take one or more actions to account for the cell movement type being quasi-Earth-fixed.

In some implementations of the method and apparatuses described herein, to take the one or more actions is to transmit, to the UE, a second signaling indicating a beam fixing duration for the wireless cell. Additionally or alternatively, to take the one or more actions is to: transmit, to the UE, a second signaling indicating a time instant at which a beam switching occurs. Additionally or alternatively, the first signaling indicates a quasi-collocation relationship of a type “quasi-fixed” or “quasi-Earth-fixed”. Additionally or alternatively, the device is further to: receive, from the UE, a second signaling indicating a signal quality measurement; and wherein to take the one or more actions is to discard, in response to the signal quality measurement being performed prior to a latest quasi-Earth-fixed beam switching instance, the signal quality measurement as obsolete. Additionally or alternatively, the device is further to: transmit, to the UE, a second signaling indicating a configuration of multiple measurements and reporting for the UE in each of multiple beam dwelling periods; and wherein to take the one or more actions is to receive, from the UE, a third signaling indicating signal quality measurements in accordance with the configuration of multiple measurements and reporting. Additionally or alternatively, the UE is one of multiple UEs, and the device is further to: receive, from the each of the multiple UEs, second signaling indicating signal quality measurements; and wherein to take the one or more actions is to use the signal quality measurements from the multiple UEs to predict future signal quality measurements for one or more of the multiple UEs. Additionally or alternatively, the device comprises a base station.

### BRIEF DESCRIPTION OF THE DRAWINGS

Various aspects of the present disclosure for signal measurement in non-terrestrial networks with quasi-Earth-fixed cells are described with reference to the following Figures. The same numbers may be used throughout to reference like features and components shown in the Figures.

FIG. 1 illustrates an example of a wireless communications system that supports signal measurement in non-terrestrial networks with quasi-Earth-fixed cells in accordance with aspects of the present disclosure.

FIG. 2 illustrates an example of an Earth-moving cell.

FIG. 3 illustrates an example of an Earth-fixed cell.

FIG. 4 illustrates an example of a quasi-Earth-fixed cell.

FIG. 5 illustrates an example of signal strength variations as a result of beam switching.

FIG. 6 illustrates an example block diagram of components of a device (e.g., a UE) that supports signal measurement in non-terrestrial networks with quasi-Earth-fixed cells in accordance with aspects of the present disclosure.

FIG. 7 illustrates an example block diagram of components of a device (e.g., a base station that supports signal measurement in non-terrestrial networks with quasi-Earth-fixed cells in accordance with aspects of the present disclosure.

FIGS. 8-14 illustrate flowcharts of methods that support signal measurement in non-terrestrial networks with quasi-Earth-fixed cells in accordance with aspects of the present disclosure.

### DETAILED DESCRIPTION

Implementations of signal measurement in non-terrestrial networks with quasi-Earth-fixed cells are described. Quasi-Earth-fixed cells typically have a limited resolution of beam angles in practice, and hence the satellite fixes a beam (e.g., an angle) for a certain duration before switching to the next beam (e.g., the next angle). Accordingly, an Earth-fixed cell may be implemented as a quasi-Earth-fixed cell. While this typically does not cause coverage loss or handover for most UEs, it may still affect measurements performed by the UEs. For example, if a UE adopts a sliding window scheme for combining multiple signal quality measurements on synchronization signal/physical broadcast channel (SS/PBCH) blocks, channel state information reference signal (CSI-RS), and so forth, switching from one beam to another beam by the satellite may make a sudden change in the signal strength, which may be in the order of multiple decibels (dBs). As a result, for example, the UE's estimate of the signal strengths may not be updated fast enough if the UE is not aware of the phenomenon.

In one or more implementations, the techniques discussed herein indicate information regarding quasi-Earth-fixed beam switching to the UE, such as at least one of beam fixing time durations, start of beam dwelling periods, an estimate of the sudden decrease or increase in the signal strength due to quasi-Earth-fixed beam switching, and so forth. Once the UE is informed of this information, the UE may use the information in different ways to compensate or adjust its measurements and the succeeding actions accordingly.

In one or more implementations, the UE receives an indication that the cell movement is of type quasi-Earth-fixed. The UE may further receive indication of least one of beam fixing time durations, start time of beam dwelling periods, or an estimate of the sudden decrease or increase in the signal strength due to quasi-Earth-fixed beam switching. The UE then uses this information for adjusting signal measurements and the corresponding actions so that the UE accounts for the cell movement.

Additionally or alternatively, in response to the indication that the cell movement is of type quasi-Earth-fixed, the UE may not average over a window longer than a beam dwelling period. Older signal quality measurements may be discarded as obsolete, allowing the UE to avoid using signal quality measurements from previous beams.

Additionally or alternatively, the network or base station may configure multiple measurements for a UE during the beam dwelling period, allowing the network or base station to learn the UE-specific pattern of signal quality change. The network or base station may then use UE reports associated with the measurements to predict the UE-specific pattern in future beam dwelling periods and take appropriate action.

Accordingly, by utilizing the described techniques, a UE is able to account for changes in signal quality measurements when an NGSO satellite is switching from one beam to another.

Aspects of the present disclosure are described in the context of a wireless communications system. Aspects of the present disclosure are further illustrated and described with reference to device diagrams and flowcharts that relate to signal measurement in non-terrestrial networks with quasi-Earth-fixed cells.

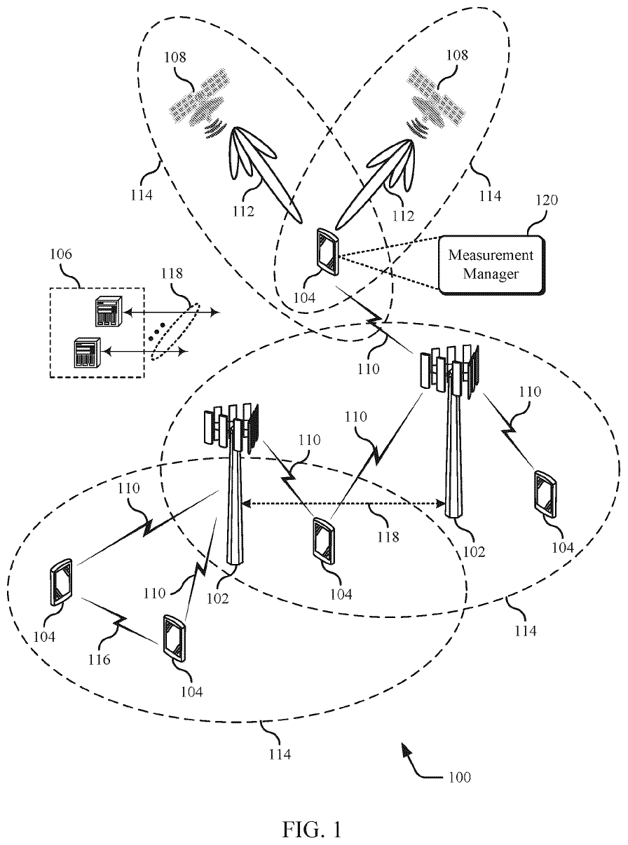

FIG. 1 illustrates an example of a wireless communications system 100 that supports signal measurement in non-terrestrial networks with quasi-Earth-fixed cells in accordance with aspects of the present disclosure. The wireless communications system 100 may include one or more base stations 102, one or more UEs 104, a core network 106, and one or more non-terrestrial stations (NTSs) 108, such as satellite access nodes. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a new radio (NR) network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be, or include, or may be referred to as a base transceiver station, an access point, a NodeB, an eNodeB (eNB), a next-generation NodeB (gNB), a Radio Head (RH), a relay node, an integrated access and backhaul (IAB) node, or other suitable terminology. A base station 102 and a UE 104 may communicate via a communication link 110, which may be a wireless or wired connection. For example, a base station 102 and a UE 104 may perform wireless communication over a NR-Uu interface. The one or more NTSs 108 described herein may be or include any type of TRPs (which may be onboard geostationary and/or geosynchronous (GEO) satellites), medium earth orbit (MEO) satellites, low earth orbit (LEO) satellites, HAPS, UAV, aircraft, or any other vehicle travelling in the earth's atmosphere, orbiting in outer space, and the like. Any entity referred to as a non-terrestrial station (NTS) in the present disclosure may be referring to a satellite, a satellite access node, NTN node, next generation radio access network (NG-RAN) node, NT-TRP, NTN TP, NTN RP, and similar type entities. A NTS 108 and a UE 104 may communicate via a communication link 112, which may be a wireless connection via a transmission beam and/or a reception beam.

A base station 102 and/or a NTS 108 may provide a geographic coverage area 114 for which the base station 102 and/or the NTS 108 may support services (e.g., voice, video, packet data, messaging, broadcast, etc.) for one or more UEs 104 within the geographic coverage area. For example, a base station 102 and a UE 104 may support wireless communication of signals related to services (e.g., voice, video, packet data, messaging, broadcast, etc.) according to one or multiple radio access technologies. Similarly, a NTS 108 and a UE 104 may support wireless communication of signals related to services (e.g., voice, video, packet data, messaging, broadcast, etc.) according to one or multiple radio access technologies. In some implementations, a base station 102 may be moveable, such as when implemented as a gNB onboard a satellite associated with an NTN. In some implementations, different geographic coverage areas 114 associated with the same or different radio access technologies may overlap, and different geographic coverage areas 114 may be associated with different base stations 102 and/or with different NTSs 108. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region or coverage area 114 of the wireless communications system 100. A UE 104 may include or may be referred to as a mobile device, a wireless device, a remote device, a handheld device, a customer premise equipment (CPE), a subscriber device, or as some other suitable terminology. In some implementations, the UE 104 may be referred to as a unit, a station, a terminal, or a client, among other examples. Additionally, or alternatively, a UE 104 may be referred to as an Internet-of-Things (IoT) device, an Internet-of-Everything (IoE) device, or as a machine-type communication (MTC) device, among other examples. In some implementations, a UE 104 may be stationary in the wireless communications system 100. In other implementations, a UE 104 may be mobile in the wireless communications system 100, such as an earth station in motion (ESIM).

The one or more UEs 104 may be devices in different forms or having different capabilities. Some examples of UEs 104 are illustrated in FIG. 1. A UE 104 may be capable of communicating with various types of devices, such as the base stations 102, other UEs 104, NTSs 108, or network equipment (e.g., the core network 106, a relay device, a gateway device, an integrated access and backhaul (IAB) node, a location server that implements the location management function (LMF), or other network equipment). Additionally, or alternatively, a UE 104 may support communication with other base stations 102 or UEs 104, which may act as relays in the wireless communications system 100.

A UE 104 may also support wireless communication directly with other UEs 104 over a communication link 116. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 118 (e.g., via an S1, N2, or other network interface). The base stations 102 may communicate with each other over the backhaul links 118 (e.g., via an X2, Xn, or another network interface). In some implementations, the base stations 102 may communicate with each other directly (e.g., between the base stations 102). In some other implementations, the base stations 102 and/or NTSs 108 may communicate with each other indirectly (e.g., via the core network 106). In some implementations, one or more base stations 102 may include subcomponents, such as an access network entity, which may be an example of an access node controller (ANC). The ANC may communicate with the one or more UEs 104 through one or more other access network transmission entities, which may be referred to as remote radio heads, smart radio heads, gateways, transmission-reception points (TRPs), and other network nodes and/or entities.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)), and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

According to implementations, one or more of the UEs 104, the base stations 102, and/or one or more of the NTSs 108 are operable to implement various aspects of signal measurement in non-terrestrial networks with quasi-Earth-fixed cells, as described herein. For instance, the base station 102 (or an NTS 108) indicate information regarding quasi-Earth-fixed beam switching to the UE 104, such as at least one of beam fixing time durations, start of beam dwelling periods, or an estimate of the sudden decrease of increase in the signal strength due to quasi-Earth-fixed beam switching. Once the UE 104 is informed of this information, a measurement manager 120 of the UE may use the information in different ways to compensate or adjust its signal quality measurements and the resulting actions accordingly.

In aspects of this disclosure, enhancements to NTNs are taken into consideration. For example, specifying enhancements for NG-RAN based NTNs according to the following assumptions with implicit compatibility to support high altitude platform station (HAPS) and air to ground (ATG) scenarios is taken into consideration: geostationary orbit (GSO) and NGSO (LEO, MEO, or HEO) with transparent payload or regenerative payload; Earth fixed tracking area; Earth fixed & Earth moving cells for NGSO; frequency division duplex (FDD) mode; UEs with global navigation satellite systems (GNSS) capabilities; both very small aperture terminals (“VSAT”) devices with directive antenna (including fixed and moving platform mounted devices and commercial handset terminals (e.g., Power class 3) are supported in frequency range 1 (FR1); only “VSAT” devices with directive antenna (including fixed and moving platform mounted devices) are supported in above 10 GHz bands.

In aspects of this disclosure, Earth-moving cell and Earth-fixed cell scenarios are taken into consideration regarding cell movement for NGSO (LEO/MEO/HEO) satellites. Earth-moving cell refers to the scenario where the cell moves as the NGSO satellites travels in the orbit. Implementation of this scenario is simple from the satellite's perspective because the satellite does not change its beam or cell configuration as it travels in the orbit. A cost of this simplicity is more frequent handovers by the UEs. Earth-fixed cell refers to the scenario where the NGSO satellite fixes the cell with respect to the ground. An advantage of this scenario is smaller overhead for mobility and handover for the UE on the ground as the duration of the cell observed on the ground is significantly longer compared to the case of Earth-moving cell.

The difference becomes more significant with narrower beams (provided that the number of beams per cell is fixed). The reason is that with Earth-moving cells, the duration of the cells become smaller as the beams become narrower and/or as the satellite travels at a higher velocity with respect to an observer on the ground; while with Earth-fixed cells, the duration of the cells only depends on how long the satellite is observed in a sufficiently high altitude, which then depends on the velocity of the satellite and not the beam-width.

However, in practice, Earth-fixed cells may be implemented by electronic beamforming and not mechanical beamforming, e.g., the satellite switches from one beam to the next beam frequently to simulate Earth-fixed beams or cells. This scenario is referred to as quasi-Earth-fixed beam or quasi-Earth-fixed cell.

One issue with quasi-Earth-fixed cells is that there is a limited resolution of beam angles in practice, and hence the satellite fixes a beam (angle) for a certain duration before switching to the next beam (angle). While this is not expected to cause coverage loss or handover for most UEs, it may still affect measurements performed by the UEs. For example, if a UE adopts a sliding window scheme for combining multiple measurements on SS/PBCH blocks, CSI-RS, etc., switching from one beam to another beam by the satellite may make a sudden change in the signal strength, which may be in the order of multiple decibels. As a result, the UE's estimate of the signal strengths may not be updated fast enough if the UE is not aware of the time instants that beam switching occurs.

Methods and systems are proposed in the present disclosure to address this issue.

In aspects of this disclosure, defining solutions enabling New Radio and NG-RAN to support NTNs is taken into consideration. This includes, for example, transparent-payload-based or regenerative-payload-based GSO and/or NGSO network scenarios addressing at least 3GPP power class 3 UE with GNSS capability in both Earth fixed and/or moving cell configurations.

In aspects of this disclosure, enhancements for NG-RAN based NTNs is taken into consideration, such as in order to support new scenarios to cover deployments in frequency bands above 10 GHz; offer optimized performance especially when addressing handset terminals (including smartphones with more realistic assumptions on antenna gains instead of 0 dBi antenna gain with the specific realistic antenna gain assumption to be determined at the working group level) with respect to coverage considering the NTN characteristics such as large propagation delay and satellite movement; provide mobility and service continuity enhancements considering the NTN characteristics such as large propagation delay and satellite movement; address requirements that mandate the network operator to cross check the UE location reported by the UE, which needs to be carried out in order to fulfil the regulatory requirements (e.g., Lawful intercept, emergency call, Public Warning System, and so forth) regarding a network verified UE location i.e., to be able to check the UE reported location information (e.g. estimate UE location at the network side) and specify if needed mechanisms to fulfil the regulatory requirements.

In one or more implementations, “VSAT” device with external antenna on moving platform is equivalent to a device that operate on platforms in motion, and this is referred to as ESIM.

The detailed objectives are to specify enhancing features to Rel-15, 16 & 17's NR radio interface & NG-RAN as follows:

In aspects of this disclosure, coverage enhancement is taken into consideration. In some situations, objectives are focused on the applicability of the solutions developed by general NR coverage enhancement to NTN, and identifying potential issues and enhancements if necessary, considering the NTN characteristics including large propagation delay and satellite movement. Only NTN-specific characteristics are to be included in this coverage enhancement work, otherwise it should be part of other work (e.g., UL enhancement of coverage). Work is to cover the use case of voice and low-data rate services using commercial smartphones with more realistic assumptions on antenna gains instead of 0 dBi currently assumed for link budget analysis for non-terrestrial networks. The specific realistic antenna gain assumption may be determined. The evaluation should also take into account any related regulatory requirements, e.g., International Telecommunication Union (ITU) limitation of power flux density.

For example, a phase may focus on the following (to derive clear & limited scope): evaluate the coverage performance and identify the candidate physical radio channels that have coverage issues specific to NTN with following target services; and VoIP and low-data rate services for commercial handset terminals

The following items are examples of areas to consider: NTN-specific repetitions enhancements for the relevant channels; NTN-specific techniques for improved diversity and/or reduced polarization loss; improved performance of low-rate codecs in link budget limited situation including reducing RAN protocol overhead for VoNR (e.g., without introducing a new codec).

RAN is to determine whether the study phase has identified any need for NTN-specific coverage enhancements. If needed, the set of NTN-specific aspects to consider will be updated.

In aspects of this disclosure, NR-NTN deployment in above 10 GHz bands is taken into consideration. The following assumptions are taken as a baseline for this consideration: GSO and NGSO (e.g., LEO, MEO, HEO) based satellite access to be considered (e.g., ESIM scenarios for NGSO in Ka band need not be considered in this WI; targeted UE types, such as fixed and mobile VSAT. VSAT UE characteristics from 3GPP technical report (TR) 38.821 to be considered in priority but additional NTN UE classes may be considered if justified (regarding mobile VSAT, three types of terminal and scenario exist; airborne, maritime and land based ESIM; which type(s) to be specified depends on the outcome of regulation analysis and co-existence study; FDD mode is assumed for satellite operation above 10 GHz, while time division duplex (TDD) mode is assumed for terrestrial operation in frequency range 2 (FR2); the ITU-R harmonized Ka band will serve as reference; co-existence between overlapping NTN and TN band portions is out of scope of this consideration.

Objectives for NR-NTN deployment in above 10 GHz bands includes study and identify NTN example band: analysis of regulations and adjacent channel co-existence scenarios. The example band shall be identified early. Additional bands can be introduced in a release-independent manner. For example, this study and identification includes consider the satellite harmonized Ka band as a reference, according to ITU allocation; taking into account deployment type (e.g. VSAT, ESIM), scenarios, and ITU-R/regional regulations, define an example band suitable for development of generic 3GPP minimum performance requirements (the example RAN4 band may be a portion of or the entire harmonized Ka band). By way of another example, this study and identification includes study implications of FDD operation in FR2 and derive requirements for the identified example band appropriately; satellite bands introduced in 3GPP for NTN for FDD need not impact the existing 3GPP TDD specifications for terrestrial bands adjacent to the NTN band. By way of another example, this study and identification includes relevant coexistence scenarios and analysis to be considered in RAN4, if and where applicable, to ensure that satellite bands introduced in 3GPP for NTN shall not impact the existing specifications and shall not cause degradation (in the sense of RAN4 co-existence studies) to networks in 3GPP specified terrestrial bands adjacent to the NTN band. In that, it is assumed that the NTN-TN adjacent band coexistence will be performed at the harmonized Ka band edges. The outcome is expected to be applicable to all NTN-TN adjacent band scenarios (if any) in the whole Ka band range where applicable and regulations allow. By way of another example, this study and identification includes, for the above examples, RAN4 process as agreed for NTN in FR1 should be used for coexistence analysis in above 10 GHz bands. By way of another example, this study and identification includes definition of NTN band(s) above 10 GHz does not change the current FR1/FR2 definition, nor automatically apply to future terrestrial bands defined in this frequency region.

Objectives for NR-NTN deployment in above 10 GHz bands includes specify Rx/transmit (Tx) requirements for satellite access node and different VSAT UE class (not only 60 cm aperture) as appropriate for the identified example band.

Objectives for NR-NTN deployment in above 10 GHz bands includes identify values for physical layer parameters chosen from the existing FR1 and FR2 sets. The following set of parameters to specify, but not necessarily limited to, are listed as follows: time relationship related enhancement (e.g., K_offset); subcarrier spacing for different uplink (UL)/downlink (DL) signals/channels; physical random access channel (PRACH) configuration index for FDD above 10 GHz.

In aspects of this disclosure, network verified UE location is taken into consideration. This includes a study phase focusing on the following (to derive clear & limited scope): study detailed regulatory requirement for network-verified UE location, e.g. accuracy requirement (at RAN plenary), including further clarification on network verified UE location and its relationship to network-based positioning, and study and evaluate, if needed, solutions for network to verify UE reported location information. Whether any need for network verified UE location specification support has been identified is also determined.

In aspects of this disclosure, NTN-TN and NTN-NTN mobility and service continuity enhancements is taken into consideration. This consideration includes considering existing methods from NR TN as well as outcome of Release 17 NR NTN outcome as baseline for NTN-TN mobility. This consideration also includes specifying NTN-TN and NTN-NTN measurement/mobility and service continuity enhancements.

In one or more implementations, an indication of beam fixing time is provided to a UE 104. UEs 104 in a cell are served by a number of satellite beams. The number may be one, in the special case that each beam covers the area of one cell, to a larger number of beams determined based on the satellite hardware implementation, network configuration, expected coverage and throughput performance, number of satellites in the constellation, number of satellites in the vicinity, current traffic load, and other such parameters. This number may change in large time scales, but it is generally expected to remain constant over short time scales.

It is reasonable to assume that, in a typical implementation, the satellite may switch all beams of a cell simultaneously in order to “quasi-fix” the beams or cell. Therefore, in the discussions herein, the terms beam and cell may be used interchangeably when making a reference to beam fixing times, beam dwelling times, and so on. For example, the terms quasi-Earth-fixed beams and quasi-Earth-fixed cells may be used interchangeably as quasi-Earth-fixed cells are implemented by applying quasi-Earth-fixed beams.

The beam fixing time in this context is the time duration during which the satellite fixes the beams (beam angles) in a quasi-Earth-fixed cell. This quantity may be referred to as other terms such as beam dwelling time, beam dwelling period, or beam fixing period. Depending on parameters and factors such as the beam-width, beam angle resolution, and the velocity of the satellite, the beam fixing time may be, for example, in the order of 100 seconds down to several seconds.

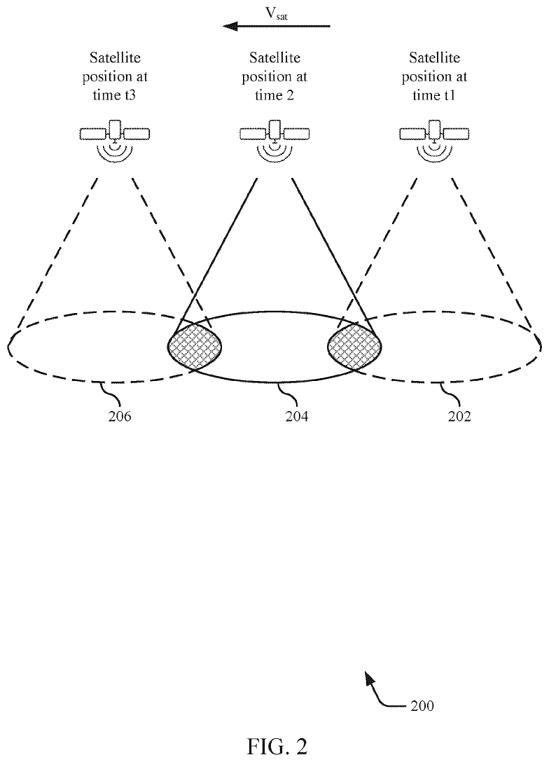

The concept is illustrated in the FIGS. 2, 3, and 4 in comparison with other cell movement scenarios.

FIG. 2 illustrates an example 200 of an Earth-moving cell. In the example 200 the satellite is moving from right to left. As illustrated, at time t1 the cell is at 202, at time t2 the cell is at 204, and at time t3 the cell is at 206.

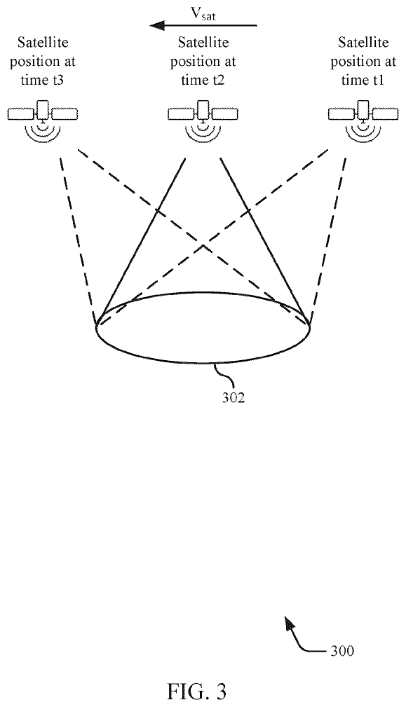

FIG. 3 illustrates an example 300 of an Earth-fixed cell. In the example 300 the satellite is moving from right to left. As illustrated, the cell 302 at times t1, t2, and t3 remains the same. This is accomplished, for example, by mechanically turning the satellite or turning the antenna.

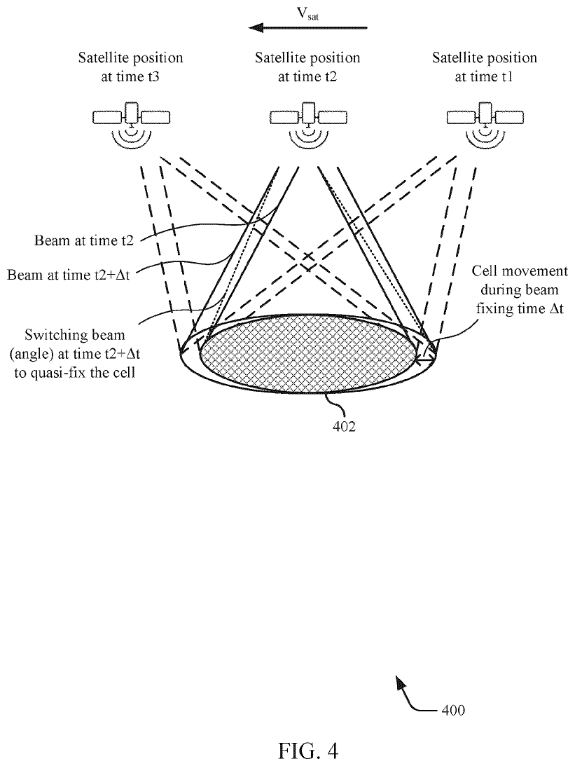

FIG. 4 illustrates an example 400 of a quasi-Earth-fixed cell. In the example 400 the satellite is moving from right to left. As illustrated, the cell 402 at times t1, t2, and t3 remains approximately the same. This is accomplished, for example, using beamforming. The satellite fixes the beam for the beam dwelling time, then switches to a different beam.

The cell movement shown in the quasi-Earth-fixed cell scenario of example 400 introduces a jitter effect or a ripple effect to the signal strength as observed at a fixed location with respect to the ground. The variations may depend on the UE location with respect to the cell boundary and direction of the satellite movement.

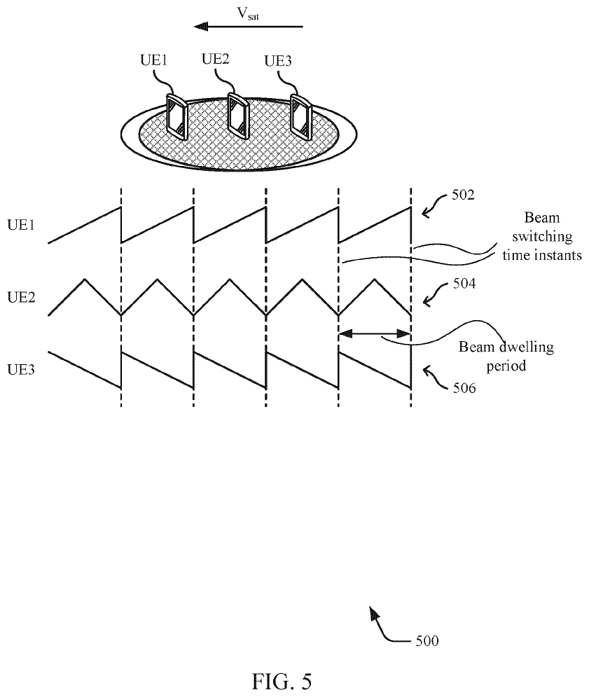

FIG. 5 illustrates an example 500 of signal strength variations as a result of beam switching. In the example 500 the satellite is moving from right to left. As illustrated, the signal strength variations may depend on the UE location with respect to the cell boundary and direction of the satellite movement.

For example, as shown at 502, when the satellite switches to a new beam, signal strength at UE1 starts low (e.g., because UE1 is at the far edge (relative to the satellite) of the cell), rises (e.g., as the satellite gets more overhead or closer to UE1), then drops off sharply at the next beam switching instant. By way of further example, as shown at 504, when the satellite switches to a new beam, signal strength at UE2 starts low (e.g., because the satellite is further away from UE3), rises (e.g., as the satellite gets more overhead or closer to UE2), then drops (e.g., as the satellite moves further away from UE2). By way of another example, as shown at 506, when the satellite switches to a new beam, signal strength at UE3 starts high (e.g., because UE3 is at the close edge (relative to the satellite) of the cell), drops (e.g., as the satellite gets further away from UE3), then rises sharply at the next beam switching instant.

It can be seen that, especially for UEs close to the cell edge, beam switching may cause a sudden change in the signal strength. Unless taken into consideration, that may introduce an error to the UEs' channel estimate resulting in overutilization (UE1) or underutilization (UE3) of the channel, at least temporarily at the beginning of each beam dwelling period.

In one or more implementations, the beam fixing time or duration may be constant for all the beams in the cell during the lifetime of the cell. The constant duration may be signaled in a system information block type x (SIB #x) broadcast by the RAN node (e.g., gNB, base station, non-terrestrial station). The base station 102 (e.g., gNB) may be implemented fully or partially onboard the satellite, in a regenerative-payload architecture, or located on the ground, in a transparent-payload architecture. The duration may be indicated in a time unit such as milliseconds, number of slots associated with a subcarrier spacing, number of frames, number of symbols, or a combination thereof.

The UE 104 may then receive the SIB #x and use the information for measuring and computing the signal strength.

While signaling the beam fixing duration may be useful as an alert to the UE 104 for employing an appropriate estimation method, the start of a beam dwelling period uses an additional indication. In one or more implementations, the start of the beam dwelling period is additionally indicated.

In one example, the indication of the start of the beam dwelling period may be through a broadcast signaling. Then, the UE 104 may assume that beam switching occurs at time instants to, t0+Δt, t0+2Δt, . . . where to denotes the indicated start of a beam dwelling period and Δt denotes the beam fixing time or duration.

In another example, the indication of the start of the beam dwelling period may be a UE-specific or group signaling. For example, a downlink control information (DCI) message or a medium-access control (MAC) control element (CE) message may indicate to a UE t104 hat the slot in which the message is received is the start of a beam dwelling period (t0).

In yet another example, the DCI message or MAC CE may further comprise an offset value after which a beam switching occurs. Then, if the message is received at time t and the indicated time offset is t′, then the UE 104 may assume that a beam switching will occur at time t0=t+t′.

In yet another example, transmission of a dedicated signal such as a reference signal may indicate to the UE 104 that a beam switching time occur in the current slot or after a certain offset.

In one or more implementations, the beam fixing time or duration may be variable, for example, as an observer may observe a different relative velocity of the satellite when it is closer to the observer's zenith compared to when the satellite is closer to the horizon.

In one or more implementations, the UE 104 may be indicated by a broadcast, UE-specific, or group signaling that a new beam dwelling period occurs at the time of indication or after a certain offset.

The UE 104 may behave in any of a variety of different manners based at least in part on, for example, the beam fixing time or the start of the beam dwelling period.

In one or more implementations, the UE 104 may be indicated through a configuration or signaling by the network that the cell movement is of type quasi-Earth-fixed. Then, the UE 104 does not assume that it may average over consecutive measurements of a signal. In some implementations, the UE 104 discards previous measurement results upon detecting a sudden change in the measurement results (e.g., a change by at least a threshold amount).

Additionally or alternatively, the UE 104 may be additionally indicated a beam fixing time or duration. Then, the UE 104 may not average over a longer window than the beam fixing time or duration. The UE 104 may discard measurement results that are older than the indicated beam fixing time or duration.

In one or more implementations, the indication to the UE 104 may be through a quasi-collocation (QCL) relationship.

In one or more implementations, a new type of QCL is defined, e.g., QCL Type E, which indicates to the UE 104 that a characteristic of the signal may change, without notification, due to beam switching for implementing quasi-Earth-fixed beams.

Additionally or alternatively, an existing QCL Type (e.g., A/B/C/D) relationship is additionally indicated to be of type quasi-Earth-fixed, which indicates to the UE 104 that the signal characteristic(s) are expected to be quasi-collocated according to the existing specification except for changes due to beam switching for implementing quasi-Earth-fixed beams. The resulting QCL Type combination may be denoted in relation with the original QCL Type, e.g., QCL Types A*, B*, C*, or D*.

For example, a new type of spatial QCL (QCL Type D* or QCL Type E) may indicate to the UE 104 that a second signal (target signal) is quasi-collocated with a first signal (source signal). Then, the UE 104 may apply a similar Rx filter for receiving the second signal as the Rx filter the UE 104 applies for receiving the first signal, while the UE 104 expects to observe a change of signal characteristics due to beam switching for implementing a quasi-Earth-fixed beam.

If a signal is indicated QCL of the new type according to the above implementations, the standard specification or a new configuration may limit the range of sudden changes in the signal characteristics due to the beam switching.

As discussed above, the network (e.g., base station 102, gNB) may indicate through configuration and signaling to the UE 104 that a cell/beam is of type quasi-fixed, which may then be considered by the UE 104 for performing signal strength measurements. The network may further inform the UE 104 of parameters such as the beam fixing time or duration and the start of a beam dwelling period to assist the UE 104 further with performing appropriate measurements. The network may additionally, or alternatively, signal the start of a beam dwelling time either at the time it occurs or in advance by a certain time offset.

In addition to these techniques, the network may take further actions to take the beam switching into account. Examples are as follows.

In one or more implementations, the base station 102 (e.g., gNB) may consider channel measurements obsolete if the associated measurement was performed prior to the latest quasi-Earth-fixed beam switching instance.

Additionally or alternatively, the base station 102 (e.g., gNB) may configure multiple measurements and reporting by a UE 104 in each beam dwelling period. Then, the base station 102 (e.g., gNB) may learn the behavior of the signal strength observed by the UE 104 during beam dwelling periods. Examples of the difference between signal strengths are illustrated for UE1, UE2, UE3 in FIG. 5. Then, the base station 102 (e.g., gNB) may predict the signal strength changes associated with the UE during a certain beam dwelling period and/or an amount of decrease (e.g., UE1 of FIG. 5) or increase (e.g., UE3 of FIG. 5) of the signal strength when a quasi-Earth-fixed beam switching occurs. The base station 102 (e.g., gNB) may then use the predicted values for link adaptation, power control, and so on for the UE 104.

The base station 102 (e.g., gNB) may apply artificial intelligence (AI) or machine learning (ML) techniques for learning the signal strength behavior as observed by a UE 104 during beam dwelling periods and at the instants of quasi-Earth-fixed beam switching.

Additionally or alternatively, the base station 102 (e.g., gNB) may collect and combine the measurement results from multiple UEs for learning and prediction, e.g., by applying AI or ML techniques.

In aspects of this disclosure, radio resource management is taken into consideration. The UE 104 in an NTN system with quasi-Earth-fixed beams or cells should be aware of the beam switching phenomenon and take appropriate actions accordingly. In one or more implementations, upon receiving a configuration or indication that a serving NTN cell and/or a neighbor NTN cell is of type quasi-Earth-fixed, the UE 104 may neglect (e.g., not take action in response to) a sudden decrease in the channel quality of the serving cell or a sudden increase in the channel quality of a neighbor NTN cell for handover. In some implementations, the UE 104 may neglect (e.g., not take action in response to) the sudden decrease or increase in channel qualities within a threshold amount that is determined by a maximum sudden change of channel quality due to quasi-fixed beam switching.

In aspects of this disclosure, power control is taken into consideration.

It is shown in FIG. 5 that different UEs may experience different channel quality increase/decrease patterns based on their locations in a quasi-Earth-fixed cell as well as the direction of satellite's movement. This allows the UE and/or the network to learn and predict the pattern of the channel quality increase/decrease and use the information for the rest of the lifetime of the same cell (e.g., until a handover is performed to another NTN or TN/ground cell).

One possible use case is power control. In conventional cellular systems, uplink power control is used to balance the received signal power of different UEs at the base station (e.g., gNB). Here, provided that the information of beam dwelling periods and/or the pattern of the channel quality changes is available to the UE 104, the UE 104 may use this information to make adjustments in uplink power control at the time instants that the channel quality is expected to experience a sudden change to quasi-fixed beam switching. The UE 104 may make the adjustments according to a configuration or signaling from the network.

In one or more implementations, the terms antenna, panel, and antenna panel are used interchangeably. An antenna panel may be a hardware that is used for transmitting and/or receiving radio signals at frequencies lower than 6 GHZ, e.g., frequency range 1 (FR1), or higher than 6 GHZ, e.g., frequency range 2 (FR2) or millimeter wave (mmWave). In one or more implementations, an antenna panel may comprise an array of antenna elements, where each antenna element is connected to hardware such as a phase shifter that allows a control module to apply spatial parameters for transmission and/or reception of signals. The resulting radiation pattern may be called a beam, which may or may not be unimodal and may allow the device (e.g., UE 104, node) to amplify signals that are transmitted or received from one or multiple spatial directions.

In one or more implementations, an antenna panel may or may not be virtualized as an antenna port in the specifications. An antenna panel may be connected to a baseband processing module through a radio frequency (RF) chain for each of transmission (egress) and reception (ingress) directions. A capability of a device in terms of the number of antenna panels, their duplexing capabilities, their beamforming capabilities, and so on, may or may not be transparent to other devices. In one or more implementations, capability information may be communicated via signaling or, in one or more implementations, capability information may be provided to devices without a need for signaling. In the case that such information is available to other devices such as a central unit (CU), it can be used for signaling or local decision making.

In one or more implementations, an antenna panel may be a physical or logical antenna array including a set of antenna elements or antenna ports that share a common or a significant portion of an RF chain (e.g., in-phase/quadrature (I/Q) modulator, analog to digital (A/D) converter, local oscillator, phase shift network). The antenna panel may be a logical entity with physical antennas mapped to the logical entity. The mapping of physical antennas to the logical entity may be up to implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device (e.g., node) associated with the antenna panel (including power amplifier/low noise amplifier (LNA) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In one or more implementations, depending on implementation, a “panel” can have at least one of the following functionalities as an operational role of Unit of antenna group to control its Tx beam independently, Unit of antenna group to control its transmission power independently, Unit of antenna group to control its transmission timing independently. The “panel” may be transparent to another node (e.g., next hop neighbor node). For certain condition(s), another node or network entity can assume the mapping between device's physical antennas to the logical entity “panel” may not be changed. For example, the condition may include until the next update or report from device or comprise a duration of time over which the network entity assumes there will be no change to the mapping. Device may report its capability with respect to the “panel” to the network entity. The device capability may include at least the number of “panels”. In one implementation, the device may support transmission from one beam within a panel; with multiple panels, more than one beam (one beam per panel) may be used for transmission. Additionally or alternatively, more than one beam per panel may be supported/used for transmission.

In one or more implementations, an antenna port is defined such that the channel over which a symbol on the antenna port is conveyed can be inferred from the channel over which another symbol on the same antenna port is conveyed.

Two antenna ports are said to be quasi co-located (QCL) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Two antenna ports may be quasi-located with respect to a subset of the large-scale properties and different subset of large-scale properties may be indicated by a QCL Type. The QCL Type can indicate which channel properties are the same between the two reference signals (e.g., on the two antenna ports). Thus, the reference signals can be linked to each other with respect to what the device can assume about their channel statistics or QCL properties. For example, qcl-Type may take one of the following values. Other qcl-Types may be defined based on combination of one or large-scale properties:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}.

Spatial Rx parameters may include one or more of: angle of arrival (AoA,) Dominant AoA, average AoA, angular spread, Power Angular Spectrum (PAS) of AoA, average AoD (angle of departure), PAS of AoD, transmit/receive channel correlation, transmit/receive beamforming, spatial channel correlation, etc.

The QCL-TypeA, QCL-TypeB and QCL-TypeC may be applicable for all carrier frequencies, but the QCL-TypeD may be applicable only in higher carrier frequencies (e.g., mmWave, FR2 and beyond), where essentially the device may not be able to perform omni-directional transmission, e.g., the device would need to form beams for directional transmission. A QCL-TypeD between two reference signals A and B, the reference signal A is considered to be spatially co-located with reference signal B and the device may assume that the reference signals A and B can be received with the same spatial filter (e.g., with the same receive (RX or Rx) beamforming weights).

An “antenna port” according to one or more implementations may be a logical port that may correspond to a beam (resulting from beamforming) or may correspond to a physical antenna on a device. In one or more implementations, a physical antenna may map directly to a single antenna port, in which an antenna port corresponds to an actual physical antenna. Additionally or alternatively, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In one or more implementations, a TCI-state (Transmission Configuration Indication) associated with a target transmission can indicate parameters for configuring a quasi-collocation relationship between the target transmission (e.g., target RS of demodulation reference signal (DM-RS) ports of the target transmission during a transmission occasion) and a source reference signal(s) (e.g., synchronization signal block (SSB)/CSI-RS/SRS) with respect to quasi co-location type parameter(s) indicated in the corresponding TCI state. The TCI describes which reference signals are used as QCL source, and what QCL properties can be derived from each reference signal. A device can receive a configuration of a plurality of transmission configuration indicator states for a serving cell for transmissions on the serving cell (e.g., between a serving gNB and a smart repeater). In one or more implementations, a TCI state includes at least one source RS to provide a reference (device assumption) for determining QCL and/or spatial filter.

In one or more implementations, a UL TCI state is provided if a device is configured with separate DL/UL TCI by RRC signaling. The UL TCI state may include a source reference signal which provides a reference for determining UL spatial domain transmission filter for the UL transmission (e.g., dynamic-grant/configured-grant based physical uplink shared channel (PUSCH), dedicated physical uplink control channel (PUCCH) resources) in a component carrier (CC) or across a set of configured CCs/BWPs.

In one or more implementations, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides QCL Type-D indication (e.g., for device-dedicated physical downlink control channel (PDCCH)/physical downlink shared channel (PDSCH) and is used to determine UL spatial transmission filter (e.g., for UE-dedicated PUSCH/PUCCH for a CC or across a set of configured CCs/BWPs. In one example, the UL spatial transmission filter is derived from the RS of DL QCL Type D in the joint TCI state. The spatial setting of the UL transmission may be according to the spatial relation with a reference to the source RS configured with qcl-Type set to ‘typeD’ in the joint TCI state.

In one or more implementations, a spatial relation information associated with a target transmission can indicate parameters for configuring a spatial setting between the target transmission and a reference RS (e.g., SSB/CSI-RS/SRS). For example, the device may transmit the target transmission with the same spatial domain filter used for reception the reference RS (e.g., DL RS such as SSB/CSI-RS). In another example, the device may transmit the target transmission with the same spatial domain transmission filter used for the transmission of the reference RS (e.g., UL RS such as SRS). A device can receive a configuration of a plurality of spatial relation information configurations for a serving cell for transmissions on the serving cell.

It should be noted that the different steps or acts described for the various implementations and examples, in the text and in the flowcharts, may be permuted.

It should also be noted that each configuration may be provided by one or multiple configurations. An earlier configuration may provide a subset of parameters while a later configuration may provide another subset of parameters. Additionally or alternatively, a later configuration may override values provided by an earlier configuration or a pre-configuration.

It should also be noted that a configuration may be provided by a radio resource control (RRC) signaling, a MAC signaling, a physical layer signaling such as a DCI message, a combination thereof, or other methods. A configuration may include a pre-configuration or a semi-static configuration provided by the standard, by the vendor, by the network/operator, or a combination thereof. Each parameter value received through configuration or indication may override previous values for a similar parameter.

It should also be noted that L1/L2 control signaling may refer to control signaling in layer 1 (physical layer) or layer 2 (data link layer). Particularly, an L1/L2 control signaling may refer to an L1 control signaling such as a DCI message or an uplink control information (UCI) message, an L2 control signaling such as a MAC message, or a combination thereof. A format and an interpretation of an L1/L2 control signaling may be determined by the standard, a configuration, other control signaling, or a combination thereof.

It should also be noted that any parameter discussed herein may appear, in practice, as a linear function of that parameter in signaling or specifications.

It should also be noted that there is a discussion herein of performing measurements for beam training on reference signals. Additionally or alternatively, in one or more implementations a measurement may be performed on resources that are not necessarily configured for reference signals, but rather a node may measure a receive signal power and obtain a receive signal strength indicator (RSSI) or the like.

It should also be noted that reference is made herein to beam indication. A beam indication may refer to an indication of a reference signal by an ID or indicator, a resource associated with a reference signal, a spatial relation information including information of a reference signal or a reciprocal of a reference signal (in the case of beam correspondence).

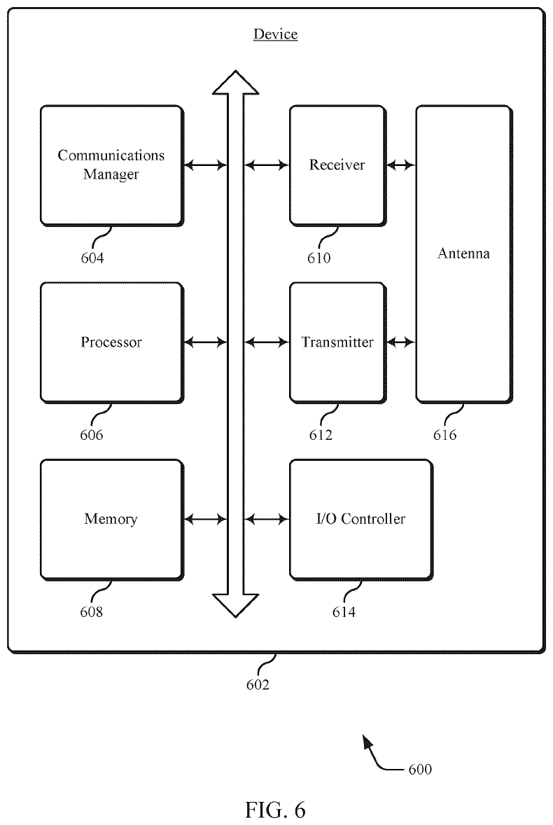

FIG. 6 illustrates an example of a block diagram 600 of a device 602 that supports signal measurement in non-terrestrial networks with quasi-Earth-fixed cells in accordance with aspects of the present disclosure. The device 602 may be an example of a UE 104 as described herein. The device 602 may support wireless communication and/or network signaling with one or more base stations 102, other UEs 104, network entities and devices, or any combination thereof. The device 602 may include components for bi-directional communications including components for transmitting and receiving communications, such as a communications manager 604, a processor 606, a memory 608, a receiver 610, a transmitter 612, and an I/O controller 614. The communications manager 604 may include, for example, a measurement manager 120 of FIG. 1. These components may be in electronic communication or otherwise coupled (e.g., operatively, communicatively, functionally, electronically, electrically) via one or more interfaces (e.g., buses).

The communications manager 604, the receiver 610, the transmitter 612, or various combinations thereof or various components thereof may be examples of means for performing various aspects of the present disclosure as described herein. For example, the communications manager 604, the receiver 610, the transmitter 612, or various combinations or components thereof may support a method for performing one or more of the functions described herein.

In some implementations, the communications manager 604, the receiver 610, the transmitter 612, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 606 and the memory 608 coupled with the processor 606 may be configured to perform one or more of the functions described herein (e.g., by executing, by the processor 606, instructions stored in the memory 608).

Additionally or alternatively, in some implementations, the communications manager 604, the receiver 610, the transmitter 612, or various combinations or components thereof may be implemented in code (e.g., as communications management software or firmware) executed by the processor 606. If implemented in code executed by the processor 606, the functions of the communications manager 604, the receiver 610, the transmitter 612, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 604 may be configured to perform various operations (e.g., receiving, monitoring, transmitting) using or otherwise in cooperation with the receiver 610, the transmitter 612, or both. For example, the communications manager 604 may receive information from the receiver 610, send information to the transmitter 612, or be integrated in combination with the receiver 610, the transmitter 612, or both to receive information, transmit information, or perform various other operations as described herein. Although the communications manager 604 is illustrated as a separate component, in some implementations, one or more functions described with reference to the communications manager 604 may be supported by or performed by the processor 606, the memory 608, or any combination thereof. For example, the memory 608 may store code, which may include instructions executable by the processor 606 to cause the device 602 to perform various aspects of the present disclosure as described herein, or the processor 606 and the memory 608 may be otherwise configured to perform or support such operations.

For example, the communications manager 604 may support wireless communication and/or network signaling at a device (e.g., the device 602, a UE) in accordance with examples as disclosed herein. The communications manager 604 and/or other device components may be configured as or otherwise support an apparatus, such as a UE, including a transceiver; a processor coupled to the transceiver, the processor and the transceiver configured to cause the apparatus to: receive a first signaling indicating a cell movement type associated with a wireless cell; and take, based at least in part on the cell movement type being quasi-Earth-fixed, one or more actions to account for the cell movement type being quasi-Earth-fixed.

Additionally, the apparatus (e.g., a UE) includes any one or combination of: where to take the one or more actions is to neglect an increase or a decrease of a quality of a signal of the wireless cell within a threshold quality value; where the processor and the transceiver are further configured to cause the apparatus to: receive a second signaling indicating a value of beam fixing duration for the wireless cell; and where to take the one or more actions is to discard, if a signal measurement is older than the beam fixing duration, the signal measurement as obsolete; where the processor and the transceiver are further configured to cause the apparatus to: receive a second signaling indicating a time instant at which a beam switching occurs; and where to take the one or more actions is to neglect an increase or a decrease of a signal quality for a threshold amount of time after the time instant; where the first signaling indicates a quasi-collocation relationship of a type “quasi-fixed” or “quasi-Earth-fixed”; where to take the one or more actions is to: learn a signal quality pattern of the signal; and adjust a signal quality measurement based at least in part on the signal quality pattern; where to take the one or more actions is to: use signal quality measurements without averaging consecutive signal quality measurements; where the processor and the transceiver are further configured to cause the apparatus to: receive a second signaling indicating a beam fixing duration for the wireless cell; and where to take the one or more actions is to use signal quality measurements without averaging the signal quality measurements over a window longer than the beam fixing duration; where the apparatus comprises a user equipment.

The communications manager 604 and/or other device components may be configured as or otherwise support a means for wireless communication and/or network signaling at a UE, including receiving a first signaling indicating a cell movement type associated with a wireless cell; and taking, based at least in part on the cell movement type being quasi-Earth-fixed, one or more actions to account for the cell movement type being quasi-Earth-fixed.

Additionally, wireless communication and/or network signaling at the UE includes any one or combination of: where taking the one or more actions comprises neglecting an increase or a decrease of a quality of a signal of the wireless cell within a threshold value; further including: receiving a second signaling indicating a value of beam fixing duration for the wireless cell; and where taking the one or more actions comprises discarding, if a signal measurement is older than the beam fixing duration, the signal measurement as obsolete; further including: receiving a second signaling indicating a time instant at which a beam switching occurs; and where taking the one or more actions comprises neglecting an increase or a decrease of a signal quality after the time instant; where the first signaling indicates a quasi-collocation relationship of a type “quasi-fixed” or “quasi-Earth-fixed”; where taking the one or more actions comprises: learning a signal quality pattern of the signal; and adjusting a signal quality measurement based at least in part on the signal quality pattern; further including: where taking the one or more actions comprises using signal quality measurements without averaging consecutive signal quality measurements; further including: receiving a second signaling indicating a beam fixing duration for the wireless cell; and where taking the one or more actions comprises using signal quality measurements without averaging the signal quality measurements over a window longer than the beam fixing duration; where the method is implemented in a user equipment.

The processor 606 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 606 may be configured to operate a memory array using a memory controller. In some other implementations, a memory controller may be integrated into the processor 606. The processor 606 may be configured to execute computer-readable instructions stored in a memory (e.g., the memory 608) to cause the device 602 to perform various functions of the present disclosure.

The memory 608 may include random access memory (RAM) and read-only memory (ROM). The memory 608 may store computer-readable, computer-executable code including instructions that, when executed by the processor 606 cause the device 602 to perform various functions described herein. The code may be stored in a non-transitory computer-readable medium such as system memory or another type of memory. In some implementations, the code may not be directly executable by the processor 606 but may cause a computer (e.g., when compiled and executed) to perform functions described herein. In some implementations, the memory 608 may include, among other things, a basic I/O system (BIOS) which may control basic hardware or software operation such as the interaction with peripheral components or devices.

The I/O controller 614 may manage input and output signals for the device 602. The I/O controller 614 may also manage peripherals not integrated into the device 602. In some implementations, the I/O controller 614 may represent a physical connection or port to an external peripheral. In some implementations, the I/O controller 614 may utilize an operating system such as iOS®, ANDROID®, MS-DOS®, MS-WINDOWS®, OS/2®, UNIX®, LINUX®, or another known operating system. In some implementations, the I/O controller 614 may be implemented as part of a processor, such as the processor 606. In some implementations, a user may interact with the device 602 via the I/O controller 614 or via hardware components controlled by the I/O controller 614.

In some implementations, the device 602 may include a single antenna 616. However, in some other implementations, the device 602 may have more than one antenna 616, which may be capable of concurrently transmitting or receiving multiple wireless transmissions. The receiver 610 and the transmitter 612 may communicate bi-directionally, via the one or more antennas 616, wired, or wireless links as described herein. For example, the receiver 610 and the transmitter 612 may represent a wireless transceiver and may communicate bi-directionally with another wireless transceiver. The transceiver may also include a modem to modulate the packets, to provide the modulated packets to one or more antennas 616 for transmission, and to demodulate packets received from the one or more antennas 616.

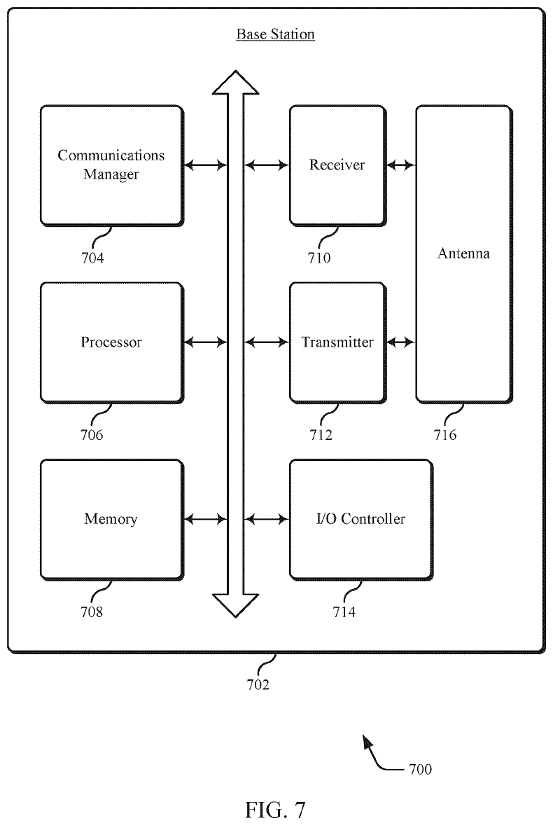

FIG. 7 illustrates an example of a block diagram 700 of a device 702 that supports signal measurement in non-terrestrial networks with quasi-Earth-fixed cells in accordance with aspects of the present disclosure. The device 702 may be an example of a base station 102, such as a gNB, as described herein. The device 702 may support wireless communication and/or network signaling with one or more base stations 102, other UEs 104, core network devices and functions (e.g., core network 106), or any combination thereof. The device 702 may include components for bi-directional communications including components for transmitting and receiving communications, such as a communications manager 704, a processor 706, a memory 708, a receiver 710, a transmitter 712, and an I/O controller 714. These components may be in electronic communication or otherwise coupled (e.g., operatively, communicatively, functionally, electronically, electrically) via one or more interfaces (e.g., buses).

The communications manager 704, the receiver 710, the transmitter 712, or various combinations thereof or various components thereof may be examples of means for performing various aspects of the present disclosure as described herein. For example, the communications manager 704, the receiver 710, the transmitter 712, or various combinations or components thereof may support a method for performing one or more of the functions described herein.

In some implementations, the communications manager 704, the receiver 710, the transmitter 712, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 706 and the memory 708 coupled with the processor 706 may be configured to perform one or more of the functions described herein (e.g., by executing, by the processor 706, instructions stored in the memory 708).

Additionally or alternatively, in some implementations, the communications manager 704, the receiver 710, the transmitter 712, or various combinations or components thereof may be implemented in code (e.g., as communications management software or firmware) executed by the processor 706. If implemented in code executed by the processor 706, the functions of the communications manager 704, the receiver 710, the transmitter 712, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 704 may be configured to perform various operations (e.g., receiving, monitoring, transmitting) using or otherwise in cooperation with the receiver 710, the transmitter 712, or both. For example, the communications manager 704 may receive information from the receiver 710, send information to the transmitter 712, or be integrated in combination with the receiver 710, the transmitter 712, or both to receive information, transmit information, or perform various other operations as described herein. Although the communications manager 704 is illustrated as a separate component, in some implementations, one or more functions described with reference to the communications manager 704 may be supported by or performed by the processor 706, the memory 708, or any combination thereof. For example, the memory 708 may store code, which may include instructions executable by the processor 706 to cause the device 702 to perform various aspects of the present disclosure as described herein, or the processor 706 and the memory 708 may be otherwise configured to perform or support such operations.

For example, the communications manager 704 may support wireless communication and/or network signaling at a device (e.g., the device 702, a base station (e.g., gNB)) in accordance with examples as disclosed herein. The communications manager 704 and/or other device components may be configured as or otherwise support an apparatus, such as a base station, including a transceiver; a processor coupled to the transceiver, the processor and the transceiver configured to cause the apparatus to: transmit, to a UE, a first signaling indicating a cell movement type associated with a wireless cell is quasi-Earth-fixed; and take one or more actions to account for the cell movement type being quasi-Earth-fixed.

Additionally, the apparatus (e.g., a base station) includes any one or combination of: where to take the one or more actions is to transmit, to the UE, a second signaling indicating a beam fixing duration for the wireless cell; where to take the one or more actions is to: transmit, to the UE, a second signaling indicating a time instant at which a beam switching occurs; where the first signaling indicates a quasi-collocation relationship of a type “quasi-fixed” or “quasi-Earth-fixed”; where the processor and the transceiver are further configured to cause the apparatus to: receive, from the UE, a second signaling indicating a signal quality measurement; and where to take the one or more actions is to discard, in response to the signal quality measurement being performed prior to a latest quasi-Earth-fixed beam switching instance, the signal quality measurement as obsolete; where the processor and the transceiver are further configured to cause the apparatus to: transmit, to the UE, a second signaling indicating a configuration of multiple measurements and reporting for the UE in each of multiple beam dwelling periods; and where to take the one or more actions is to receive, from the UE, a third signaling indicating signal quality measurements in accordance with the configuration of multiple measurements and reporting; where the UE is one of multiple UEs, and the processor and the transceiver are further configured to cause the apparatus to: receive, from the each of the multiple UEs, second signaling indicating signal quality measurements; and where to take the one or more actions is to use the signal quality measurements from the multiple UEs to predict future signal quality measurements for one or more of the multiple UEs; where the apparatus comprises a base station.

The communications manager 704 and/or other device components may be configured as or otherwise support a means for wireless communication and/or network signaling at a base station, including transmitting, to a UE, a first signaling indicating a cell movement type associated with a wireless cell is quasi-Earth-fixed; and taking one or more actions to account for the cell movement type being quasi-Earth-fixed.

Additionally, wireless communication at the base station includes any one or combination of: where taking the one or more actions comprises transmitting, to the UE, a second signaling indicating a beam fixing duration for the wireless cell; where taking the one or more actions comprises transmitting, to the UE, a second signaling indicating a time instant at which a beam switching occurs; where the first signaling indicates a quasi-collocation relationship of a type “quasi-fixed” or “quasi-Earth-fixed”; further including: receiving, from the UE, a second signaling indicating a signal quality measurement; and where taking the one or more actions comprises discarding, in response to the signal quality measurement being performed prior to a latest quasi-Earth-fixed beam switching instance, the signal quality measurement as obsolete; further including: transmitting, to the UE, a second signaling indicating a configuration of multiple measurements and reporting for the UE in each of multiple beam dwelling periods; and where taking the one or more actions comprises receiving, from the UE, a third signaling indicating signal quality measurements in accordance with the configuration of multiple measurements and reporting; where the UE is one of multiple UEs, and further including: receiving, from the each of the multiple UEs, second signaling indicating signal quality measurements; and where taking the one or more actions comprises using the signal quality measurements from the multiple UEs to predict future signal quality measurements for one or more of the multiple UEs; where the method is implemented in a base station.

The processor 706 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 706 may be configured to operate a memory array using a memory controller. In some other implementations, a memory controller may be integrated into the processor 706. The processor 706 may be configured to execute computer-readable instructions stored in a memory (e.g., the memory 708) to cause the device 702 to perform various functions of the present disclosure.

The memory 708 may include random access memory (RAM) and read-only memory (ROM). The memory 708 may store computer-readable, computer-executable code including instructions that, when executed by the processor 706 cause the device 702 to perform various functions described herein. The code may be stored in a non-transitory computer-readable medium such as system memory or another type of memory. In some implementations, the code may not be directly executable by the processor 706 but may cause a computer (e.g., when compiled and executed) to perform functions described herein. In some implementations, the memory 708 may include, among other things, a basic I/O system (BIOS) which may control basic hardware or software operation such as the interaction with peripheral components or devices.

The I/O controller 714 may manage input and output signals for the device 702. The I/O controller 714 may also manage peripherals not integrated into the device 702. In some implementations, the I/O controller 714 may represent a physical connection or port to an external peripheral. In some implementations, the I/O controller 714 may utilize an operating system such as iOS®, ANDROID®, MS-DOS®, MS-WINDOWS®, OS/2®, UNIX®, LINUX®, or another known operating system. In some implementations, the I/O controller 714 may be implemented as part of a processor, such as the processor 706. In some implementations, a user may interact with the device 702 via the I/O controller 714 or via hardware components controlled by the I/O controller 714.

In some implementations, the device 702 may include a single antenna 716. However, in some other implementations, the device 702 may have more than one antenna 716, which may be capable of concurrently transmitting or receiving multiple wireless transmissions. The receiver 710 and the transmitter 712 may communicate bi-directionally, via the one or more antennas 716, wired, or wireless links as described herein. For example, the receiver 710 and the transmitter 712 may represent a wireless transceiver and may communicate bi-directionally with another wireless transceiver. The transceiver may also include a modem to modulate the packets, to provide the modulated packets to one or more antennas 716 for transmission, and to demodulate packets received from the one or more antennas 716.

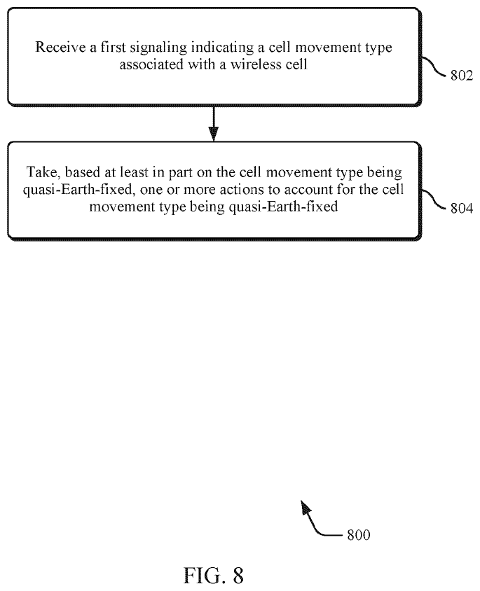

FIG. 8 illustrates a flowchart of a method 800 that supports signal measurement in non-terrestrial networks with quasi-Earth-fixed cells in accordance with aspects of the present disclosure. The operations of the method 800 may be implemented and performed by a device or its components, such as a UE 104 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 802, the method may include receiving a first signaling indicating a cell movement type associated with a wireless cell. The operations of 802 may be performed in accordance with examples as described herein. In some implementations, aspects of the operations of 802 may be performed by a device as described with reference to FIG. 1.

At 804, the method may include taking, based at least in part on the cell movement type being quasi-Earth-fixed, one or more actions to account for the cell movement type being quasi-Earth-fixed. The operations of 804 may be performed in accordance with examples as described herein. In some implementations, aspects of the operations of 804 may be performed by a device as described with reference to FIG. 1.

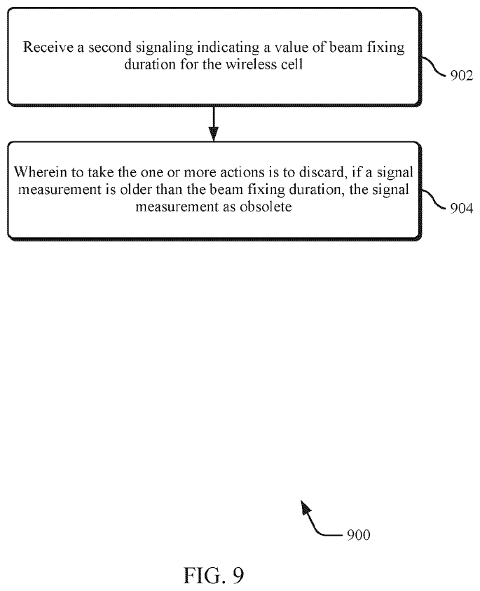

FIG. 9 illustrates a flowchart of a method 900 that supports signal measurement in non-terrestrial networks with quasi-Earth-fixed cells in accordance with aspects of the present disclosure. The operations of the method 900 may be implemented and performed by a device or its components, such as a UE 104 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 902, the method may include receiving a second signaling indicating a value of beam fixing duration for the wireless cell. The operations of 902 may be performed in accordance with examples as described herein. In some implementations, aspects of the operations of 902 may be performed by a device as described with reference to FIG. 1.

At 904, the method may include wherein to take the one or more actions is to discard, if a signal measurement is older than the beam fixing duration, the signal measurement as obsolete. The operations of 904 may be performed in accordance with examples as described herein. In some implementations, aspects of the operations of 904 may be performed by a device as described with reference to FIG. 1.

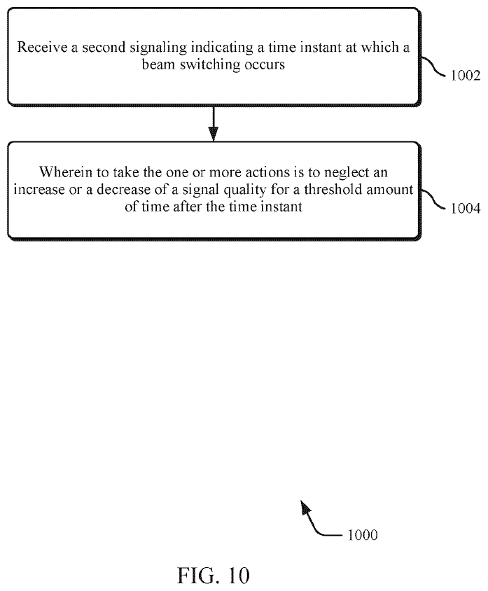

FIG. 10 illustrates a flowchart of a method 1000 that supports signal measurement in non-terrestrial networks with quasi-Earth-fixed cells in accordance with aspects of the present disclosure. The operations of the method 1000 may be implemented and performed by a device or its components, such as a UE 104 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1002, the method may include receiving a second signaling indicating a time instant at which a beam switching occurs. The operations of 1002 may be performed in accordance with examples as described herein. In some implementations, aspects of the operations of 1002 may be performed by a device as described with reference to FIG. 1.

At 1004, the method may include wherein to take the one or more actions is to neglect an increase or a decrease of a signal quality for a threshold amount of time after the time instant. The operations of 1004 may be performed in accordance with examples as described herein. In some implementations, aspects of the operations of 1004 may be performed by a device as described with reference to FIG. 1.

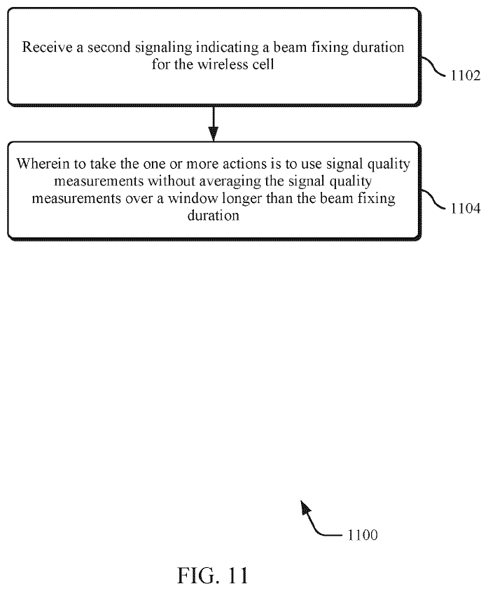

FIG. 11 illustrates a flowchart of a method 1100 that supports signal measurement in non-terrestrial networks with quasi-Earth-fixed cells in accordance with aspects of the present disclosure. The operations of the method 1100 may be implemented and performed by a device or its components, such as a UE 104 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1102, the method may include receiving a second signaling indicating a beam fixing duration for the wireless cell. The operations of 1102 may be performed in accordance with examples as described herein. In some implementations, aspects of the operations of 1102 may be performed by a device as described with reference to FIG. 1.

At 1104, the method may include wherein to take the one or more actions is to use signal quality measurements without averaging the signal quality measurements over a window longer than the beam fixing duration. The operations of 1104 may be performed in accordance with examples as described herein. In some implementations, aspects of the operations of 1104 may be performed by a device as described with reference to FIG. 1.

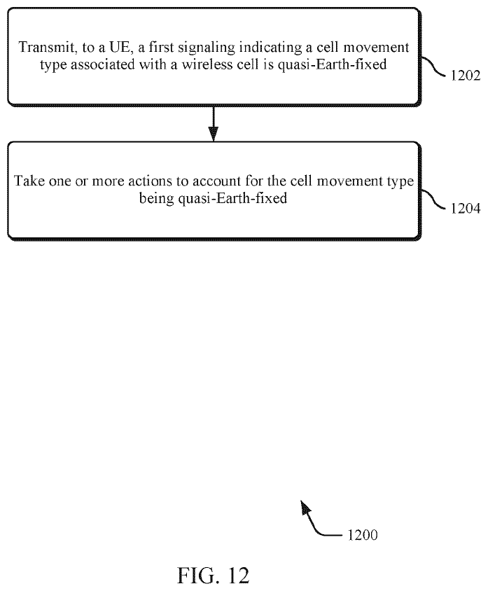

FIG. 12 illustrates a flowchart of a method 1200 that supports signal measurement in non-terrestrial networks with quasi-Earth-fixed cells in accordance with aspects of the present disclosure. The operations of the method 1200 may be implemented and performed by a device or its components, such as a base station 102 (e.g., a gNB) as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1202, the method may include transmitting, to a UE, a first signaling indicating a cell movement type associated with a wireless cell is quasi-Earth-fixed. The operations of 1202 may be performed in accordance with examples as described herein. In some implementations, aspects of the operations of 1202 may be performed by a device as described with reference to FIG. 1.

At 1204, the method may include taking one or more actions to account for the cell movement type being quasi-Earth-fixed. The operations of 1204 may be performed in accordance with examples as described herein. In some implementations, aspects of the operations of 1204 may be performed by a device as described with reference to FIG. 1.

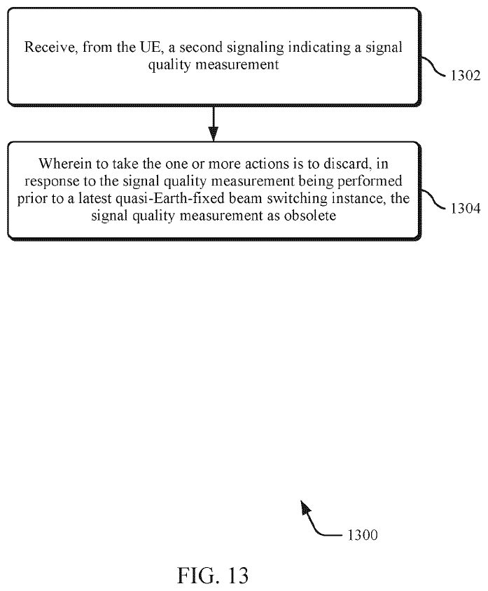

FIG. 13 illustrates a flowchart of a method 1300 that supports signal measurement in non-terrestrial networks with quasi-Earth-fixed cells in accordance with aspects of the present disclosure. The operations of the method 1300 may be implemented and performed by a device or its components, such as a base station 102 (e.g., a gNB) as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1302, the method may include receiving, from the UE, a second signaling indicating a signal quality measurement. The operations of 1302 may be performed in accordance with examples as described herein. In some implementations, aspects of the operations of 1302 may be performed by a device as described with reference to FIG. 1.

At 1304, the method may include wherein to take the one or more actions is to discard, in response to the signal quality measurement being performed prior to a latest quasi-Earth-fixed beam switching instance, the signal quality measurement as obsolete. The operations of 1304 may be performed in accordance with examples as described herein. In some implementations, aspects of the operations of 1304 may be performed by a device as described with reference to FIG. 1.

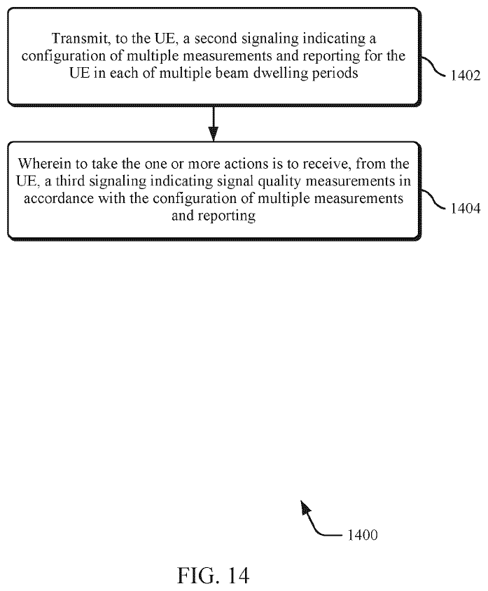

FIG. 14 illustrates a flowchart of a method 1400 that supports signal measurement in non-terrestrial networks with quasi-Earth-fixed cells in accordance with aspects of the present disclosure. The operations of the method 1400 may be implemented and performed by a device or its components, such as a base station 102 (e.g., a gNB) as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1402, the method may include transmitting, to the UE, a second signaling indicating a configuration of multiple measurements and reporting for the UE in each of multiple beam dwelling periods. The operations of 1402 may be performed in accordance with examples as described herein. In some implementations, aspects of the operations of 1402 may be performed by a device as described with reference to FIG. 1.

At 1404, the method may include wherein to take the one or more actions is to receive, from the UE, a third signaling indicating signal quality measurements in accordance with the configuration of multiple measurements and reporting. The operations of 1404 may be performed in accordance with examples as described herein. In some implementations, aspects of the operations of 1404 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined. The order in which the methods are described is not intended to be construed as a limitation, and any number or combination of the described method operations may be performed in any order to perform a method, or an alternate method.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C, or AB or AC or BC, or ABC (i.e., A and B and C). Similarly, a list of one or more of A, B, or C means A or B or C, or AB or AC or BC, or ABC (i.e., A and B and C). Similarly, a list of at least one of A; B; or C means A or B or C, or AB or AC or BC, or ABC (i.e., A and B and C). Similarly, a list of one or more of A; B; or C means A or B or C, or AB or AC or BC, or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
receive a first signaling indicating a cell movement type associated with a wireless cell; and
take, based at least in part on the cell movement type being quasi-Earth-fixed, one or more actions to account for the cell movement type being quasi-Earth-fixed.

2. The UE of claim 1, wherein, to take the one or more actions, the at least one processor is configured to cause the UE to neglect an increase or a decrease of a quality of a signal of the wireless cell within a threshold quality value.

3. The UE of claim 1, wherein the at least one processor is further configured to cause the UE to:
receive a second signaling indicating a value of beam fixing duration for the wireless cell, wherein, to take the one or more actions, the at least one processor is configured to cause the UE to discard, if a signal measurement is older than the beam fixing duration, the signal measurement as obsolete.

4. The UE of claim 1, wherein the at least one processor is further configured to cause the UE to:
receive a second signaling indicating a time instant at which a beam switching occurs, wherein, to take the one or more actions, the at least one processor is configured to cause the UE to neglect an increase or a decrease of a signal quality for a threshold amount of time after the time instant.

5. The UE of claim 1, wherein the first signaling indicates a quasi-collocation relationship of a type “quasi-fixed” or “quasi-Earth-fixed”.

6. The UE of claim 1, wherein, to take the one or more actions, the at least one processor is configured to cause the UE to:
learn a signal quality pattern of the signal; and
adjust a signal quality measurement based at least in part on the signal quality pattern.

7. The UE of claim 1, wherein, to take the one or more actions, the at least one processor is configured to cause the UE to:
use signal quality measurements without averaging consecutive signal quality measurements.

8. The UE of claim 1, wherein the at least one processor is further configured to cause the UE to:
receive a second signaling indicating a beam fixing duration for the wireless cell, wherein, to take the one or more actions, the at least one processor is configured to cause the UE to use signal quality measurements without averaging the signal quality measurements over a window longer than the beam fixing duration.

9. (canceled)

10. A base station for wireless communication, comprising:
at least one memory; and
at least one processor coupled with the at least one memory and configured to cause the base station to;
transmit, to a user equipment (UE), a first signaling indicating a cell movement type associated with a wireless cell is quasi-Earth-fixed; and
take one or more actions to account for the cell movement type being quasi-Earth-fixed.

11. The base station of claim 10, wherein, to take the one or more actions, the at least one processor is configured to cause the base station to transmit, to the UE, a second signaling indicating a beam fixing duration for the wireless cell.

12. The base station of claim 10, wherein, to take the one or more actions, the at least one processor is configured to cause the base station to transmit, to the UE, a second signaling indicating a time instant at which a beam switching occurs.

13. The base station of claim 10, wherein the first signaling indicates a quasi-collocation relationship of a type “quasi-fixed” or “quasi-Earth-fixed”.

14. The base station of claim 10, wherein the at least one processor is further configured to cause the base station to:
receive, from the UE, a second signaling indicating a signal quality measurement, wherein, to take the one or more actions, the at least one processor is configured to cause the base station to discard, in response to the signal quality measurement being performed prior to a latest quasi-Earth-fixed beam switching instance, the signal quality measurement as obsolete.

15. The base station of claim 10, wherein the at least one processor is further configured to cause the base station to:
transmit, to the UE, a second signaling indicating a configuration of multiple measurements and reporting for the UE in each of multiple beam dwelling periods, wherein, to take the one or more actions, the at least one processor is configured to cause the base station to receive, from the UE, a third signaling indicating signal quality measurements in accordance with the configuration of multiple measurements and reporting.

16. The base station of claim 10, wherein the UE is one of multiple UEs, and the at least one processor is further configured to cause the base station to:
receive, from the each of the multiple UEs, second signaling indicating signal quality measurements, wherein, to take the one or more actions, the at least one processor is configured to cause the base station to use the signal quality measurements from the multiple UEs to predict future signal quality measurements for one or more of the multiple UEs.

17. (canceled)

18. A method performed by a user equipment (UE), the method comprising:
receiving a first signaling indicating a cell movement type associated with a wireless cell; and
taking, based at least in part on the cell movement type being quasi-Earth-fixed, one or more actions to account for the cell movement type being quasi-Earth-fixed.

19. The method of claim 18, further comprising:
receiving a second signaling indicating a value of beam fixing duration for the wireless cell, wherein taking the one or more actions comprises discarding, if a signal measurement is older than the beam fixing duration, the signal measurement as obsolete.

20. The method of claim 18, further comprising:
receiving a second signaling indicating a time instant at which a beam switching occurs, wherein taking the one or more actions comprises neglecting an increase or a decrease of a signal quality after the time instant.

21. A processor for wireless communication, comprising:
at least one controller coupled with at least one memory and configured to cause the processor to:
receive a first signaling indicating a cell movement type associated with a wireless cell; and
take, based at least in part on the cell movement type being quasi-Earth-fixed, one or more actions to account for the cell movement type being quasi-Earth-fixed.

22. The processor of claim 21, wherein the at least one controller is further configured to cause the processor to:
receive a second signaling indicating a value of beam fixing duration for the wireless cell, wherein, to take the one or more actions, the at least one controller is further configured to cause the processor to discard, if a signal measurement is older than the beam fixing duration, the signal measurement as obsolete.
